(19) United States
(12) Patent Application Publication
(10) Pub. No.: US 2023/0261309 A1
(43) Pub. Date: Aug. 17, 2023

(54) Rechargeable Battery System

(71) Applicant: Vanderhall Motor Works, Inc., Provo, UT (US)

(72) Inventors: Stephen Hall, Provo, UT (US); Christopher Johnson, Provo, UT (US); Matthew Rawle, Mapleton, UT (US)

(73) Assignee: Vanderhall Motor Works, Inc., Provo, UT (US)

(21) Appl. No.: 18/184,581

(22) Filed: Mar. 15, 2023

Related U.S. Application Data
(63) Continuation-in-part of application No. 17/878,816, filed on Aug. 1, 2022.
(60) Provisional application No. 63/319,832, filed on Mar. 15, 2022.
(60) Provisional application No. 63/228,096, filed on Aug. 1, 2021.

(51) Int. Cl. H01M 50/298; H01M 10/42; H01M 50/503; H01M 50/204

(52) U.S. Cl. CPC H01M 50/298; H01M 10/425; H01M 50/503; H01M 50/204; H01M 2010/4271

(57) ABSTRACT

A rechargeable battery system is disclosed. The battery system includes a collection of at least four flat cells, each with a positive terminal extending from one side of each cell and a negative terminal extending from an opposite side of each cell, and wherein the cells are arranged in an alternating stack with a first stack side and a second stack side, such that each cell, has its positive or negative terminal mechanically and electrically connected at a junction to the positive or negative terminal of an adjacent cell. A first board located on the first stack side, including a plurality of first connectors extending from the first board for mechanically and electrically connecting to the junctions on the first stack side. A battery management processor is included that is electrically connected to each first connector by a plurality of electrical conductors. With this configuration, the state of at least each pair of cells connected at each first connector can be monitored by the battery management processor.

### CROSS REFERENCES

The present application is a continuation-in-part of U.S. Provisional Patent Application No. 63/319,832 entitled “Battery Control Module” and filed Mar. 15, 2022; as well as a continuation-in-part of U.S. patent application Ser. No. 17/878,816 entitled “Electric Vehicle Battery Heat Exchange System,” filed on Aug. 1, 2022, which application was, in turn, was a continuation-in-part of U.S. Provisional Patent Application No. 63/228,096 entitled “Vehicle Battery System with Cooling of Cells,” filed Aug. 1, 2021. The entire contents of the above-listed applications are hereby incorporated by reference for all purposes.

### TECHNICAL FIELD

This invention relates to rechargeable batteries and methods for manufacturing them.

### BACKGROUND

Portable electric power is increasing in use and in desirability. Electric vehicles, especially electric cars are gaining popularity. The batteries which store the electric energy can be difficult to manufacture and troublesome to repair, if damaged. Conventional manufacture techniques typically rely on wire connections, such as soldering or other types of connections that can be time and labor intensive to manufacture and even more difficult to repair. Advances in design and manufacture would be beneficial.

### SUMMARY

In a first aspect, the disclosure provides a rechargeable battery system. The battery system comprises a collection of at least four flat cells, each with a positive terminal extending from one side of each cell and a negative terminal extending from an opposite side of each cell, and arranged and connected in an alternating stack with a first and second side, and wherein the cells are arranged such that each cell, except for a cell at one end of the stack, has its positive terminal mechanically and electrically connected at a junction to the negative terminal of an adjacent cell, and such that each cell, except for a cell at the other end of the stack, has its negative terminal mechanically and electrically connected at a junction to the positive terminal on an adjacent cell. The system further includes a first board located on the first stack side. The board comprises a plurality of first connectors extending from the first board for mechanically and electrically connecting to the junctions on the first stack side. A battery management processor is included on the first board. First electrical conductors electrically connect each first connector of the plurality of first connectors to the battery management processor. With this configuration, the state of at least each pair of cells connected at each first connector can be monitored by the battery management processor. Preferably, the mechanical and electrical connection of the junctions on the first stack side to the first connectors is achieved simultaneously by moving the first board and the first stack side toward each other.

In a second aspect, the rechargeable battery system also includes a second board located on the second stack side. This second board includes a plurality of second connectors extending from the second board for mechanically and electrically connecting to the junctions on the second stack side. Second electrical conductors directly or indirectly connect each second connector of the plurality of second connectors to the battery management processor. In this way, the state of each cell can be monitored by the battery management processor.

In a third aspect, the disclosure provides a method for manufacturing a rechargeable battery system. The method includes the step of providing a collection of at least four flat cells, each with a positive terminal extending from one side of each cell and a negative terminal extending from an opposite side of each cell. The cells are arranged in an alternating stack with a first stack side and a second stack side. The cells are arranged such that the positive terminal of every other cell is on the first stack side and the negative terminals of the remaining cells are on the first stack side, and such that the negative terminal of every other cell is on the second stack side and the positive terminals of the remaining cells are on the second stack side. The positive terminals of the cells on each side to the negative terminals of the adjacent cells on the same side are mechanically and electrically connected at a junction. The method also includes the step of connecting the cell at one end of the stack to a first electrical lead, and the cell at the other end to a second electric lead, wherein one of the leads is positive and the other is negative. A first board is located on the first stack side. This first board includes a plurality of first connectors extending from the first board for mechanically and electrically connecting to the junctions on the first stack side. The first board also includes a battery management processor and first electrical conductors electrically connecting each first connector to the battery management processor. With this configuration, the state of at least each pair of cells connected at each first connector can be monitored by the battery management processor. The first board and the first stack side are moved toward each other to mechanically and electrically connect the junctions on the one stack side to the first connectors on the first board.

Further aspects and embodiments are provided in the foregoing drawings, detailed description, and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

The present description will be understood more fully when viewed in conjunction with the accompanying drawings of various examples of battery systems. The description is not meant to limit the battery systems to the specific examples. Rather, the specific examples depicted and described are provided for explanation and understanding of battery systems. Throughout the description the drawings may be referred to as drawings, figures, and/or FIGs.

FIG. 1A illustrates a side perspective view of a battery system with an integrated battery management processor.

FIG. 1B illustrates an opposite side perspective view of the battery system shown in FIG. 1A.

FIG. 2A is a partial cross section of a battery system, with trays between each battery cell.

FIG. 2B is a partial cross section of a battery system, with trays between every other battery cell.

FIG. 3 is a perspective view of the battery system with the battery cells and support structure removed to illustrate an arrangement of a set of circuit boards.

FIG. 4 is a perspective view of a first circuit board with the connectors shown.

FIG. 5 is a perspective view of a second circuit board.

FIG. 6A is a side view of a connector with the battery tab inserted into the connector.

FIG. 6B is a side view of a connector with the battery junction inserted into the connector.

FIG. 7A is a side perspective view of a battery system with the first circuit board attached.

FIG. 7B is an opposite side perspective view of the battery system showing the second circuit board attached.

FIG. 8A is a side perspective view of a battery system with battery cell terminals exposed.

FIG. 8B is an opposite side perspective view of the battery system shown in FIG. 8A.

FIG. 9 is a side view of a motorized vehicle in which at least some of the battery systems described herein may be implemented.

FIGS. 10A-C illustrate various views of a vehicle chassis with a battery spine, in which vehicle at least some of the battery systems described herein may be implemented.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, the terms “battery management system” and “BMS” are intended to have a relatively broad meaning, referring to any electrical system that manages a rechargeable battery, for example by protecting the battery from operating outside safe conditions, monitoring the charge and/or temperature state of the battery, reporting that state, and balancing cells within the battery. Typically, the heart of the battery management system is the battery management processor (BMP).

Rechargeable battery systems (sometimes referred to as battery control modules), as disclosed herein, will become better understood through a review of the following detailed description in conjunction with the figures. The detailed description and figures merely provide examples of the various implementations of battery systems. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

A conventional battery management system (BMS) includes a controller, various and disparate measurement devices, and one or more communication devices or controllers. Typical systems may include wiring that extends between battery cells and the various components of the BMS. Servicing and maintenance of such a system may be difficult and time-consuming. As the number of wires in a system increases, the probability of a fault occurring in the system also increases, which may be further increased where wires of different gauge are used. The fault probability further increases as the length of wire increases. This may, in some cases, be due to the increased probability of damage to a wire. In systems or applications where the BMS may be exposed to harsh environmental conditions, the probability of damage is exacerbated. The amount and routing of wiring in the BMS may also increase the complexity of, and time for, servicing the BMS.

Implementations of battery systems described herein may address some or all of the problems described above. Such a battery system may be used in various applications and configurations, preferably in electric powered vehicles.

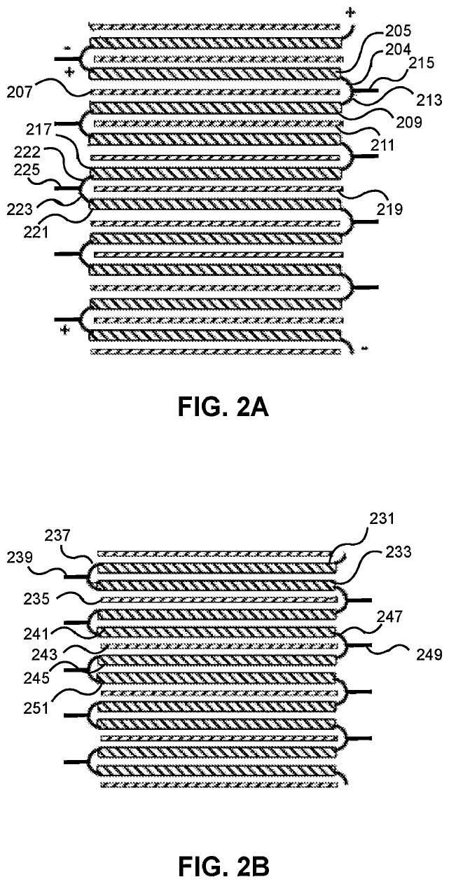

The battery system includes multiple battery cells. The multiple battery cells are arranged in a stacked configuration. Preferably, the multiple battery cells are arranged as illustrated in FIG. 2B, and described as follows; a first battery cell positioned in a first battery tray, a second battery cell positioned in a second battery tray, a third battery cell positioned in a third battery tray, and a fourth battery cell positioned in a fourth battery tray. The first battery tray, the second battery tray, the third battery tray, and the fourth battery tray may be stacked together. The first battery cell and the second battery cell may be positioned relative to each other such that a positive terminal of the first battery cell is adjacent to a negative terminal of the second battery cell. The second battery cell and the third battery cell may be positioned relative to each other such that a positive terminal of the second battery cell may be adjacent to a negative terminal of the third battery cell. The third battery cell and the fourth battery cell may be positioned relative to each other such that a positive terminal of the third battery cell may be adjacent to a negative terminal of the fourth battery cell. The battery system may further include a first connector that electrically couples the positive terminal of the first battery cell with the negative terminal of the second battery cell, and a second connector that electrically couples the positive terminal of the second battery cell with the negative terminal of the third battery cell.

A first board, preferably a printed circuit board (PCB) and a second board, also preferably a PCB may be coupled to the battery system. The first PCB may include a first battery management processor (BMP) and a first set of connectors, or interconnects. The first PCB may further include a second BMP. In some embodiments, the second PCB is a “dumb” PCB and includes only the PCB connectors. In these embodiments a “multiconductor cable” connects the PCBs. The BMPS on the first PCB handle all of the smart technology, including temperature monitoring and management, charge balance between the cells and charge level of the battery cells. In some embodiments, the second PCB may include a second BMP and a second set of PCB connectors or interconnects.

In embodiments utilizing interconnects, the first interconnect may extend from an underside of the first PCB and be positioned at least in part on a top side of the first PCB such that the first interconnect extends through the first PCB. The first PCB may be positioned such that the first interconnect touches the first connector between the first and second battery cells. The first interconnect may thereby electrically couple the first BMP to the first battery connector. The second interconnect may extend from an underside of the second PCB and be positioned at least in part on a top side of the second PCB such that the second interconnect extends through the second PCB. The second PCB may be positioned such that the second interconnect touches the second battery connector between the second and third battery cells. The second interconnect may thereby electrically couple the second BMP to the second battery connector. In embodiments utilizing sets of PCB connectors, the PCB connectors are attached to the PCBs. The PCBs are configured so that the PCB connectors act as a locating feature. The PCB connectors on the first PCB are arranged so that the first PCB is installable in a single orientation. In this way a person or robot performing the installation will only be able to install the PCB in the proper orientation. This will reduce the amount of improperly installed PCBs and will speed up the installation process. The PCB connectors on the second PCB are also configured so that the second PCB is installable in a single orientation. In addition, the configuration of the PCB connectors on the first PCB is different from the configuration of the PCB connectors on the second PCB.

The battery systems described herein improve the overall integrity of a battery system by minimizing or eliminating the need for individually attached wiring between the battery and the various components of the BMP. Because the battery systems significantly reduce wiring, the risk of faults during manufacture of the system is also significantly reduced. Additionally, the overall number of components in the battery system may be reduced. For example, because the battery system is directly adjacent to the battery cells, the same system used to monitor and control battery temperature can be used to regulate the temperature of the battery system.

The battery systems described herein lead to more efficient manufacturing. Service time, of these battery systems, is also significantly reduced compared to conventional systems. The risk of errors during servicing is also reduced. Because there are few, if any, wires, and corresponding connections to keep track of, little, if any, time is spent doing wire management. The manufacturing process is also greatly simplified and expedited because the time to plan and execute a wire routing scheme is reduced or eliminated.

The battery systems may be particularly useful in vehicular applications, especially for motorized vehicles that carry one or more passengers. Because such vehicles may be exposed to harsh environmental conditions and often rugged use, the electrical components of such vehicles may be at risk of damage. By reducing or eliminating the amount of wiring needed for the battery system, the overall integrity of the vehicle's powertrain is increased. Servicing the vehicle's battery system may also be simplified. In some implementations, a battery system can be quickly and easily exchanged when its service life has expired. For example, replacing a battery system with the battery systems described herein may be as simple as disconnecting a single cable, pulling the old system out of the vehicle, adding a new battery system, and connecting the cable to the new battery system. As another example, battery system replacement may be as simple as unsecuring the old battery system, removing it, adding a new battery system, and securing the new system to the vehicle. In such an implementation, the power and/or data interface for the battery system may be fixed so that it connects to the corresponding interface on the vehicle when the battery system is set in place.

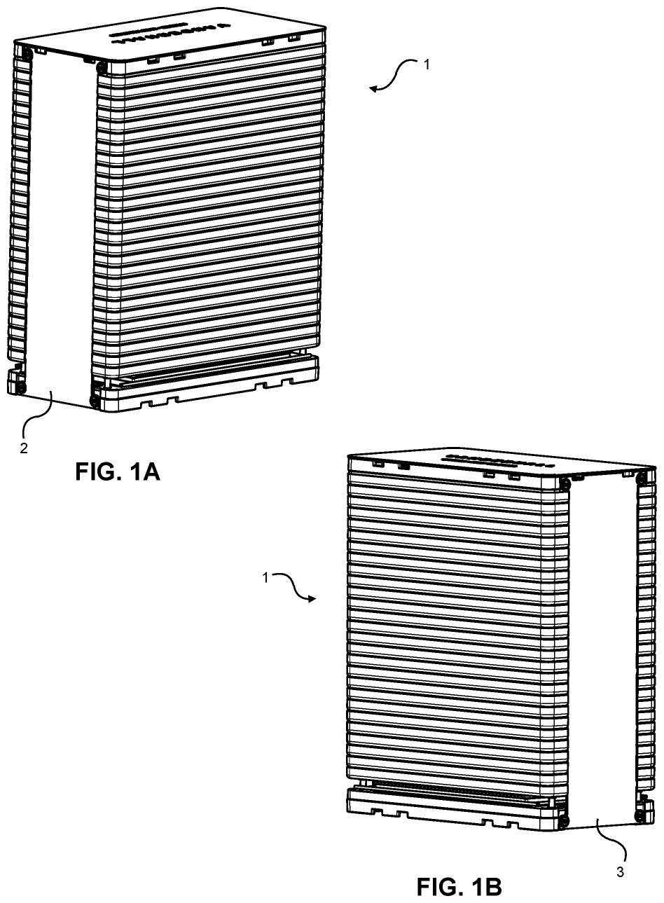

FIG. 1A illustrates a side perspective view of a battery system with an integrated battery management system. FIG. 1B illustrates an opposite side perspective view of the battery system shown in FIG. 1A. The battery system may be incorporated into a battery system of an electrically powered apparatus or device. For example, the battery system may be incorporated into a battery system of a vehicle such as a passenger vehicle, a truck, a commuter car, a van, an autocycle, a motorcycle, an off-road vehicle, a watercraft, and/or an aircraft. The battery system may include one or more battery systems, a thermal management system, structural supports for battery system components, wiring for conveying current to other vehicle components, one or more data communication links, and so forth.

The battery system 1 includes a set of battery cells. For convenience and clarity, the battery cells may be referred to herein as a “first” battery cell, a “second” battery cell, and so forth. It is to be understood that the quantity of battery cells in the battery system may not be limited by such numbering. Rather, the numbering is used to clarify relationships amongst the various components of the battery system. Similar nomenclature is used when referring to multiple instances of other components of the battery module or battery system. It is to be understood that the quantity of such components may not be limited by such numbering.

The battery cells may be secured and/or supported by a battery cell support structure. The battery cell support structure may include a first tray that holds a first battery cell and a second tray that holds a second battery cell. The first tray and the second tray may be stacked together such that the first battery cell is positioned between a bottom surface of the second tray and a top surface of the first tray. Alternatively, the second battery cell may be positioned between a bottom surface of the first tray and a top surface of the second tray. The battery system may include a stacked array of trays holding battery cells. In some implementations, one tray may support two or more cells. The trays may be linked together. For example, the trays may be rectangular and may include openings at one or more corners of the trays. A rod may be passed through the openings. The rod and trays may be secured together by a top cap and a bottom cap, with the rod secured at one or each end to the caps. As another example, the trays may include snap fittings. The first tray may snap to the second tray. A band may be wrapped around the trays across the array such that the trays are held in the stacked array by the band.

In various implementations, the battery cells may include a rigid housing. The rigid housing may enclose one or more battery cells. Electrodes for the battery cells may extend through the rigid housing. In implementations where multiple battery cells are contained within the same housing, the electrodes of some battery cells or each battery cell may protrude from the housing, or the battery cells may be interconnected within the housing with a single set of electrodes protruding from the rigid housing. Multiple instances of battery cells enclosed within rigid housings may be secured together, such as by latches, snap fittings, and/or adhesive. Various other structural arrangements for the battery system are envisioned and may accommodate the battery systems described herein.

The battery system includes a board attached to the battery cell support structure. In various implementations, the components of the battery management system may be arranged on one or more printed circuit boards (PCBs). One or more of the PCBs may be attached to the battery cell support structure. The PCB may be secured to the support structure adjacent to the set of battery cells. In a specific example, the battery system may include two boards, preferably PCBs. A first PCB may be adjacent to a first set of electrodes and a second PCB may be adjacent to a second set of electrodes. In the example depicted in FIGS. 1A-B, the PCBs are attached to cover plates 2 and 3 which are attached to the trays on opposite sides of battery system from each other, and each PCB extends along the array of trays. In various implementations, the first PCB and the second PCB may be positioned on different sides of the battery system from each other, though not necessarily opposite each other. In some implementations, the first PCB and the second PCB may be positioned on a same side of the battery system as each other, or the battery system may include one PCB that corresponds to both terminal sides of the battery cells. The arrangement of the PCBs may correspond to the terminal placement of the battery cells and/or the structural arrangement of the battery cells in the battery system.

In some embodiments, the PCB attaches to the battery support structure with a set of snap-fit latches. In some embodiments the snap-fit latches are spaced so that the PCB will not bend or bow toward the battery or bend or bow away from the battery. In some embodiments, the PCB is nested into the support structure.

FIG. 2A is a schematic cross section of battery cells stacked in the battery system. In this configuration each battery cell is held by its own tray. The battery cells are arranged in series with alternating orientations, so the positive terminals of the battery cells are adjacent to the negative terminals of the neighboring battery cells. Due to the alternating orientation of the battery cells the first positive terminal on the top of the stack is exposed, and the last negative terminal on the bottom is exposed. The battery cell terminals are connected at junctions, which mechanically and electrically join the positive terminal of each battery to the negative terminal of a neighboring battery. Battery cell 205 rests on tray 207 and is connected to battery cell 209 which rests on tray 211. On a first side of the battery system. Battery cell 205 includes negative battery terminal 204 which connects to positive battery terminal 213 of battery cell 209 forming battery junction 215. As shown, battery junction 215 is in the form of a tab that fits within a PCB connector of the first PCB and mechanically and electrically connects the battery cells to the first PCB. The battery junctions are also referred to as tabs or blades. Battery cell 217 rests on tray 219 and is connected to battery cell 221 which rests on tray 223. On a second, opposite, side of the battery system, battery cell 217 includes negative terminal 222 which connects to positive terminal 223 of battery 221 and forms a junction 225. Junction 227 is also in the form of a tab or blade that fits within a PCB connector of the second PCB and mechanically and electrically connects the battery cells to the second PCB.

FIG. 2B is a schematic cross section with two battery cells stacked on each plate. The battery cells are arranged in series with alternating orientations, so the positive terminals of the battery cells are adjacent to the negative terminals of the neighboring battery cells. Due to the alternating orientation of the battery cells the first positive terminal on the top of the stack is exposed, and the last negative terminal on the bottom is exposed. The battery cells are connected at junctions, which connect the positive terminal of each battery to the negative terminal of a neighboring battery. On a second side of the battery system, battery cells 231 and 233 rest on tray 235 and are connected at junction 237. The battery junction 237 connects the negative terminal of battery cell 231 to the positive terminal of battery cell 233. The battery junction 237 form a tab or blade 239. Tab 239 fits within a PCB connector of the second PCB and mechanically and electrically connects the battery cells to the second PCB. On a first side of the battery system, battery cell 241 rests on tray 243 and is connected to battery cell 245 which rests on battery cell 251. Battery cell 241 is connected to battery cell 245 by junction 247. The battery junction 247 connects the negative terminal of battery cell 241 to the positive terminal of battery cell 245. The battery junction 247 forms a tab 249. Tab 249 fits within a PCB connector of the first PCB and electrically connects the battery cells to the first PCB.

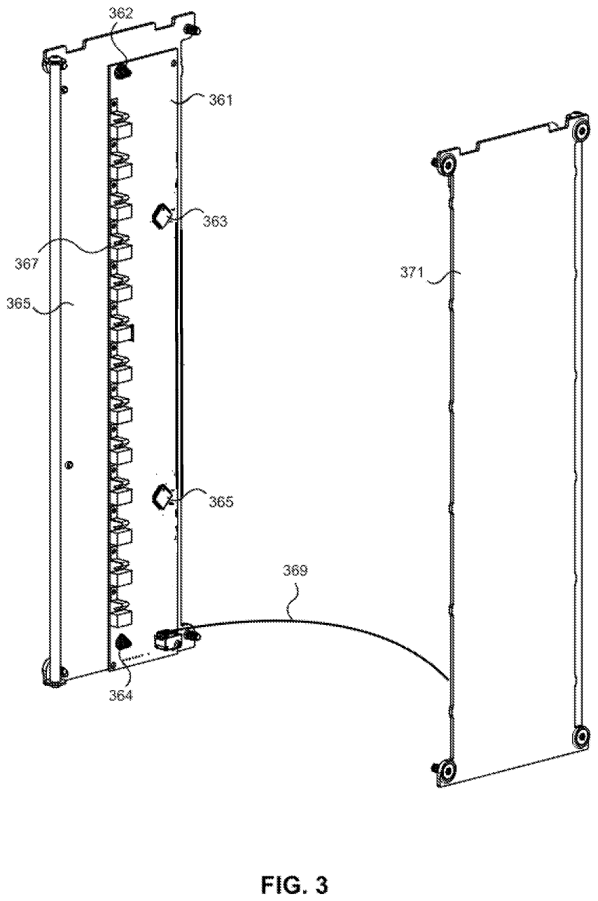

FIG. 3 depicts one arrangement of the first and second boards of the battery system. In this view the battery cell stack has been removed to give a clear picture of the PCB as it would appear when installed. The first PCB 361 with its BMP 363 is attached to a support plate 365. The first PCB 361 includes PCB connectors such as connector 367. The PCB connectors accept the tabs of the battery connectors or the junctions of the terminals of the battery cells and connect them to the first PCB. A multiconductor wire 369 connects the first PCB to the second PCB. The second PCB is attached to second support plate 371. The second PCB connects to a second BMP 365 on the first PCB. The multiconductor wire 369 connects to the second connectors of the second PCB by second electrical traces. The multiconductor wire 369 connects to third electrical traces on the first PCB which connect to the second BMP. The battery system includes lead connectors 362 and 364. The lead connectors connect to the output leads, which allow the battery system to connect to the device it is powering. Such devices include electric vehicles.

The battery system may include a first protective panel, a first PCB, a second protective panel, a second PCB, a battery management processor (BMP), a set of connectors, and various other battery management electronics. The PCBs may be mounted to the corresponding protective panels. For example, the first PCB may be attached to the first protective panel by an adhesive such that an underside of the PCB is adhered to an inside face of the protective panel. The second PCB may be similarly attached to the second protective panel. As another example, the first PCB may be attached to the first protective panel by a set of standoffs. The second PCB may be similarly attached to the second protective panel. The first PCB may be electronically coupled to the second PCB, such as by a pin connector that couples pins on the first PCB to pins on the second PCB via a multiconductor wire. The wire may be secured to a member of the support structure such as the bottom cap. In various implementations, the support structure may have integrated wiring or electrical traces. The first and second PCBs may be electronically coupled via the integrated wiring or traces. Any of a variety of connectors may electronically couple the PCBs to the integrated wiring or traces.

The BMP may be integrated with the first PCB. A first subset of the connectors may be integrated with the first PCB, and a second subset of the connectors may be integrated with the second PCB. The BMP may be positioned on a face of the first PCB that faces inwards towards the battery cells and battery support structure. The BMP may be positioned on a face of the first PCB that faces outwards. For example, the first PCB may be attached to the first protective panel by a set of standoffs, and the BMP may be positioned between the first PCB and the first protective panel. The first subset of connectors may be integrated with the first PCB on the face of the first PCB that faces towards the battery cells. Similarly, the second subset of connectors may be integrated with the second PCB on the face of the second PCB that faces towards the battery cells. The connectors may be electronically coupled to the BMP via traces in the PCBs. In some implementations, the connectors may extend through the PCBs, such as in examples where the BMP is on the outside face of the first PCB. Various of the other battery management electronics, such as a current limiter, current sensor, contactor, temperature sensor, power interface, and so forth, may be integrated with the first PCB or the second PCB. Multiple instances of the same battery management electronics may be integrated with the first and/or second PCBs. For example, a first temperature sensor may be integrated with the first PCB and a second temperature sensor may be integrated with the second PCB.

In various implementations, the first PCB may be positioned along a first side of the battery cells. The first PCB may be positioned relative to the battery cells such that a first connector may contact a positive terminal of a first battery cell, a negative terminal of a second battery cell, or a first connector that connects the positive and negative terminals of the first and second battery cells, respectively. The second PCB may be positioned along a second side of the battery cells opposite the first side and opposite the first PCB. A second set of connectors extending from the second PCB may contact a positive terminal of the second battery cell, a negative terminal of a third battery cell, or a connector that connects the positive and negative terminals of the second and third battery cells, respectively. The connectors may electronically couple the battery cells to the PCB circuitry, the BMP, and/or various of the other battery system electronics.

In various implementations, the connectors may extend from the PCBs a sufficient length to form durable electrical contact with the battery cell electrodes. The connectors may be extended from the PCBs by one or more standoffs, with additional electronics coupling the connectors to the traces in the PCBs. In some implementations, the connectors may be or include electrical traces in and/or through the PCB. The connectors may also include, for example, one or more spring mechanisms which apply a force on the connectors in the direction of the battery cells. In some implementations, the connectors may be a raised conductive pad that contacts the electrodes. The raised conductive pads may be forced against the electrodes by a securing mechanism such as latches, screws, springs, or snap fittings that secure the PDBs to the support structure adjacent to the battery cell electrodes.

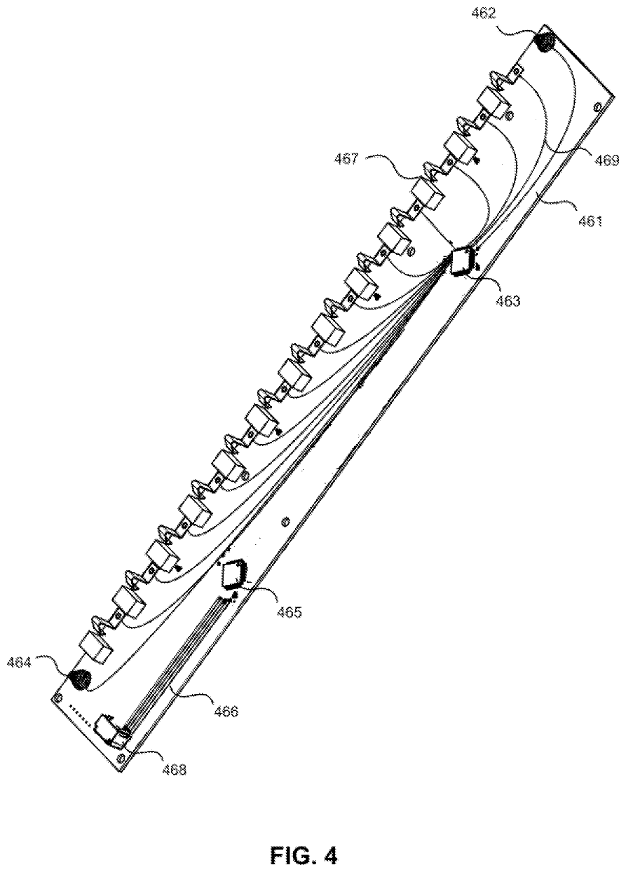

FIG. 4 illustrates an example of a PCB used in various implementations of the battery systems described herein. This PCB includes various of the features described above regarding the battery systems, including a BMP, PCB connectors, pins, and various other battery system electronics. The first PCB 461 includes a first BMP or battery management processor 463 for the first PCB 461. The BMP 463 enables measuring and monitoring the state of the battery cells. The BMP 461 measures and monitors the charge state of each battery cell, the balance of charge between battery cells, and the temperature of the battery cells. The first BMP 463 is connected to the first connectors such as connector 467 by electrical traces such as electric trace 469. The BMP on the on the PBC enables these smart features and keeps the battery running optimally.

The first PCB 461 includes PBC connectors such as PCB connector 467. These connectors accept the junction of the of the battery terminals, or the blade of the battery terminals. The PCB connectors connect to the BMP by traces in the PCB. As the PCB connecters and the battery junctions are moved toward each other, e.g. by pushing one, while the other stays stationary, a mechanical and electrical connection is simultaneously established between the battery junctions and the PCB connectors. By using PCB connectors that enable the connections to be established as the junctions and connectors are moved, e.g., by pushing, toward each other, the connections are simultaneously made without the need for solder or weld. The lack of solder or weld simplifies the installation and removes a potential failure point. By using connections that can be moved toward each other, the battery junctions and PCB connectors are able to be configured so that the first PCB is installable in a single orientation. The PCB connectors become locating features and when the battery junctions and the PCB connectors align, the first PCB is able to be installed on a first side of the battery system. If the battery junctions and the PCB connectors do not align, the first PCB cannot be installed. This orientation of battery junctions and PCB connectors is advantageous in manufacturing, correction of potential problems, and replacement of any battery cells.

The first PCB also includes a wire harness 468 or a multiconductor connector for a multiconductor wire. The multiconductor wire connects the second PCB to the first PCB. The multiconductor wire connector 468 on the first PCB is connected to the BMP by third electrical traces such as electrical trace 466. The multiconductor wire transmits all of the data from the second PCB to the first PCB. This gives more data for the battery cells and helps improve performance of the battery system. The additional data enables each battery cell to be monitored individually. With individual monitoring of each battery cell, isolated problems are able to be corrected for individual battery cells.

The PCB 461 also includes lead connectors 462 and 464. The lead connectors attach to the terminal of the first or topmost battery cell in the stack of cells and to the terminal of the last or bottommost battery cell of the stack. The lead connectors 462 and 464 connect to leads which connect the battery system to the device it is powering. In some embodiments, the terminal of the first or topmost battery cell is positive, and the terminal of the last or bottommost battery cell is negative. In other embodiments, the terminal of the first or topmost battery cell is negative, and the terminal of the last or bottommost battery cell is positive. In some embodiments, several battery systems are connected together to power a device, the leads connect the battery systems to each other as well.

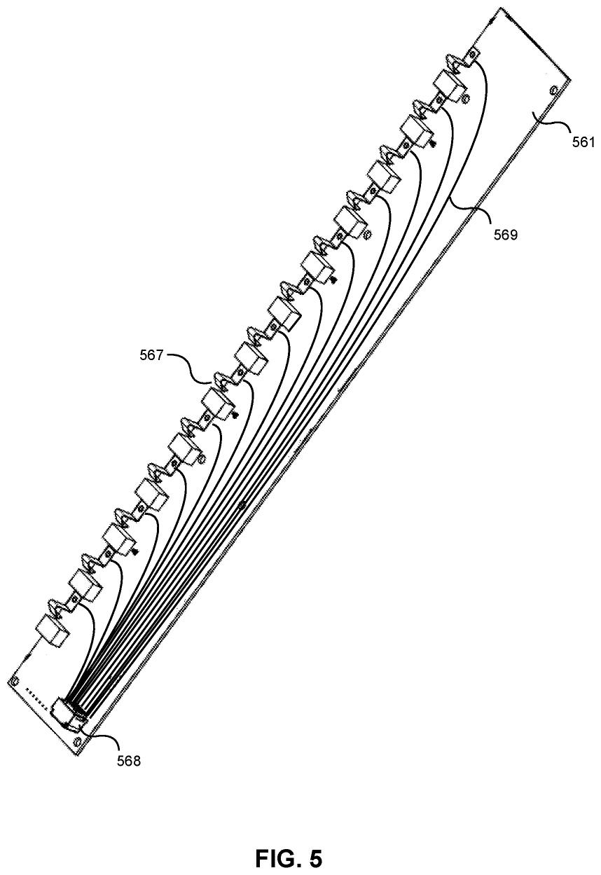

FIG. 5 is a view of the second PCB. The second PCB 561 includes PCB connectors such as PCB connector 567. These connectors accept the tab or blade of the battery junctions. The second PCB connectors such as, second PCB connector 567, connect to the BMP by second traces 569 in the second PCB. The PCB connecters enable the battery connectors to be moved in to establish a mechanical and electrical connection. The PCB connecters and the battery junctions are able to be pushed toward each other. As the second PBC connectors and the battery junctions on a second side of the battery system interact, a mechanical and electrical connection is simultaneously established between the battery junctions on the second side of the battery system and the second PCB connectors. Advantageously, the connections are made without the need for solder or weld. The lack of solder or weld simplifies the installation and removes a potential failure point. By using connections that can be moved toward one another, the battery junctions on the second side and the second PCB connectors are configured so that the second PCB is installable in a single orientation. The second PCB connectors become locating features and when the battery junctions and the PCB connectors align, the second PCB is able to be installed. If the battery junctions on the second side and the second PCB connectors do not align, the second PCB cannot be installed. This orientation of battery junctions on the second side and second PCB connections is advantageous in manufacturing, correction of potential problems, and replacement of any battery cells.

The second PCB also includes a connection 570 for a multiconductor cable. This connector is often referred to as a wire harness. The multiconductor cable connects the second PCB to the first PCB where the first PCB also has a multiconductor cable connector. The multiconductor cable connector on the first PCB is connected to the BMP by third electrical traces. The PCB connectors on the second PCB connect to the multiconductor connector on the second PCB by second electrical traces.

The locating features on the first PCB are different from the locating features of the second PCB. The configuration of first PCB connectors on the first PCB and the battery junctions on the first side of the battery system is unique to the first PCB. Likewise, the configuration of the second PCB connectors on the second PCB and battery junctions on the second side of the battery system are unique. This asymmetry of the PCBs ensures that the first PCB cannot be installed in place of the second PCB and that the second PCB cannot be installed in place of the first PCB.

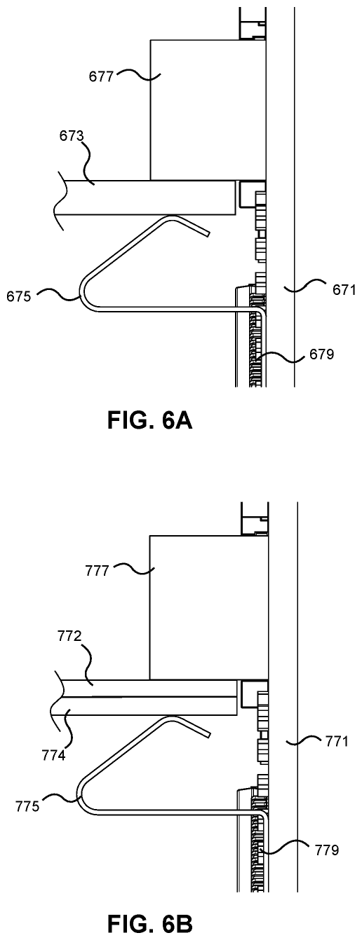

FIG. 6A is a side view of a PCB connector. These connectors are used on both the first PCB and the second PCB. The PCB connector depicted is known as a spring connector. This type of connector is often referred to as a blade and receptacle connector. These connectors are used on both the first PCB and the second PCB. In other embodiments, other types of quick connectors are used such as spade and blade connections, blade and hook connectors, pin connectors, and bullet connectors. The PCB connector is attached to the PCB 671. The connector includes a spring 675 and a block 677. Together the spring 675 and block 677 form a receptacle. The receptable receives the blade and holds it in place, making the electrical and mechanical connection. The battery junction 673 from the battery stack slides between the spring 675 and the block 677. The spring 675 is connected to an electrical trace 679 which connects the connector to the BMP. These spring connectors enable the battery connector 673 to be slid in and mechanically and electrically connect the battery cells to the PCB. The battery junction or blade 673 enters the receptacle as a PCB and a side of the battery system are moved, e.g. by pushing, toward one another. The spring connectors, like other quick connectors enable quick installation or uninstallation of the boards with the battery connection. This is advantageous for quick changes of the battery systems and the individual battery cells, as well as for easy access to batteries cells for diagnostic purposes.

FIG. 6B is a side view of a PCB connector. The PCB connector depicted is often referred to as a spring connector. Other embodiments, use other types of connectors such as spade and blade connections. The connector is attached to the PCB 771. The connector includes a spring 775 and a block 777. The blade formed from the junction of the positive terminal 772 and negative terminal 774 slides between the spring 775 and the block 777. The spring 775 is connected to a trace 779 which connects the connector to the BMP. These spring connectors enable the battery junction 773 to be slid in and mechanically and electrically connect the battery cells to the PCB. The battery junction or blade 773 enters the receptacle as a PCB and a side of the battery system are moved toward one another. The spring connectors, like other quick connectors enable quick installation or uninstallation of the boards with the battery junction. This is advantageous for quick changes of the battery systems and the individual battery cells, as well as for easy access to batteries cells for diagnostic purposes.

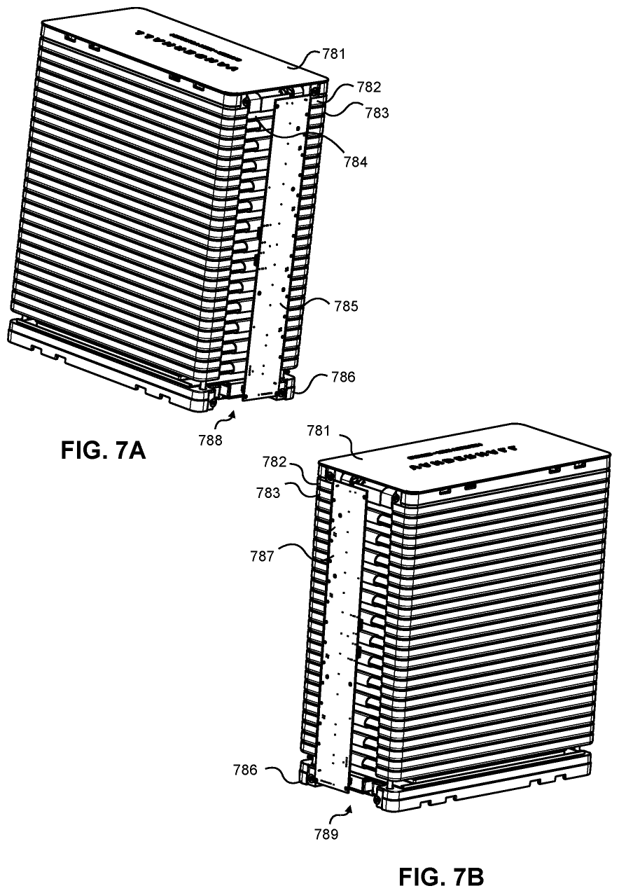

FIG. 7A illustrates a side perspective view of a battery system with a PCB of an integrated battery management system exposed, according to an implementation thereof. FIG. 7B illustrates an opposite side perspective view of the battery system shown in FIG. 7A. The illustrations in FIGS. 7A-B are similar to those in FIGS. 1A-B except the support panels for the PCBs have been removed to show an arrangement of the PCBs with respect to the battery cells and electrodes, as such may be implemented.

The battery system includes a set of battery cells. Flat battery cells, such as the pouch battery cells depicted at 784, are arranged such that a positive terminal of a first battery cell is positioned adjacent to a negative terminal of a second battery cell. The positive and negative terminals may be electrically coupled by one or more junctions. For example, the terminals may be curved tabs that extend from the battery cells and nest in contact with each other forming a junction. The battery system may include first and second PCBs mounted directly or indirectly to the set of battery cells. For example, the PCBs may be snap-fit to a battery stack support structure that also supports the battery cells. As another example, the PCBs may be attached to battery cell housing by one or more screws. A BMP may be integrated with the first PCB. The PCB may cover at least a portion of the junctions as the PCB is attached to the battery cell support structure.

In various implementations, the battery support structure includes one or more trays such as trays 782, and 783 that support corresponding battery cells. The battery cells need to be configured to fit within the trays. Flat elongate battery cells are bet adapted to fit in the trays. The flat battery cells, typically referred to as prismatic cells, can be pouches, or blocks, or other cells that would fit within the stack. Many types of rechargeable battery cells are available including lithium ion, lithium polymer, vanadium redox, Silver-Zinc, Lithium Sulfur, Nickel Cadmium (NiCd), or Nickel-metal hydride (NiMH). The trays may be rectangular. One or more corners of the trays may include means for securing the trays together, such as snap fittings, openings through which a rod may be pass, threaded openings through which bolts may be passed, and so forth. A first widthwise side of a tray may include a first cutout 788 such that a length of the tray across the middle of the tray is shorter than a length of the tray along either lengthwise edge. The cutouts of the stacked trays may define a region in which the battery cell terminal junctions are positioned. The PCB 785 may also, in various implementations, be positioned in the cutout region.

The first PCB may be attached to the battery system in the cutout region 788. For example, one or more side edges of the trays defining the cutout region may include a groove or a snap fitting. The PCB may sit in the groove or attach to the snap fitting. The groove may be a snap fitting, such as for example, where the PCB is secured in the groove by friction between the PCB and the edges of the groove. In other implementations, the PCB may be attached and/or adhered to a support panel. The support panel may be secured to one or more of the trays or one or more cap structures of the battery support structure at outermost widthwise edges of the support structure, i.e., outside the cutout region. For example, the support panel may be screwed to the support structure.

A second widthwise side of a tray may include a second cutout 789 such that a length of the tray across the middle of the tray is shorter than a length of the tray along either lengthwise edge. The cutouts of the stacked trays may define a region in which the battery cell terminal connectors are positioned. The second PCB 787 may also, in various implementations, be positioned in the cutout region.

The support structure surrounds the battery cells. A top plate 781 protects the top. The bottom plate 786 protects the bottom of the stack. Additionally, the bottom plate lifts the battery cells further from the surface on which the system is placed. The trays such as trays 782 and 783 surround the battery cells giving support to the structure and protection from the possibility of the batteries leaking.

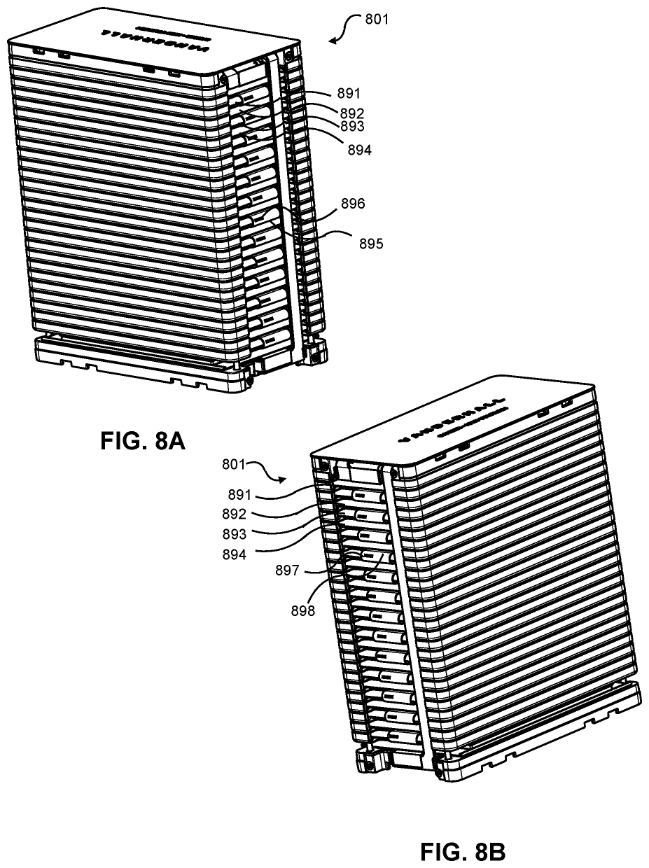

FIG. 8A illustrates a side perspective view of a battery system with battery cell connectors exposed. FIG. 8B illustrates an opposite side perspective view of the battery system shown in FIG. 8A The illustrations in FIGS. 8A-B are similar to those in FIGS. 1A-B except the support panels and PCBs have been removed to better show an arrangement of the battery cell connectors and terminals, as such may be implemented.

A battery system, in which the battery management systems described herein, may be implemented may include a set of battery cells arranged such that a positive terminal of a first battery cell 891 is positioned adjacent to, and contacts, a negative terminal of a second battery cell 892, and a positive terminal of the second battery cell is positioned adjacent to, and contacts, a negative terminal of a third battery cell 893 and a positive terminal of the third battery cell is positioned adjacent to, and contacts, a negative terminal of a fourth battery cell 894. In some embodiments, the positive terminal of the first battery cell may include a first metallic tab bent into an arc shape. The negative terminal of the second battery cell may include a second metallic tab bent into the arc shape. The first metallic tab and the second metallic tab may be nested together forming a junction. In some implementations, the terminals may be electrically coupled by the junction. The junction may form a metallic tab. In other embodiments, the battery terminals are flat ribbons welded to the battery cells, such as terminal 895. Additionally, the positive and negative terminals are connected together to form a junction. In some embodiments, the junction is a tab or a blade, that protrudes from the flat ribbon, such as blade 896. The junctions of the terminals connect to the connectors on the PCBs. For example, junction 896 which is on the first side would slide into a connector on the first PCB, forming a mechanical and electrical connection to the PCB. On the second side, flat ribbon connector 897 connects the positive terminal of one battery cell with the negative terminal of the adjacent cell. The junction of the terminals forms junction 897. Junction 897 slides into a second connector on the second PCB, as the second side and the PCB are moved toward one another.

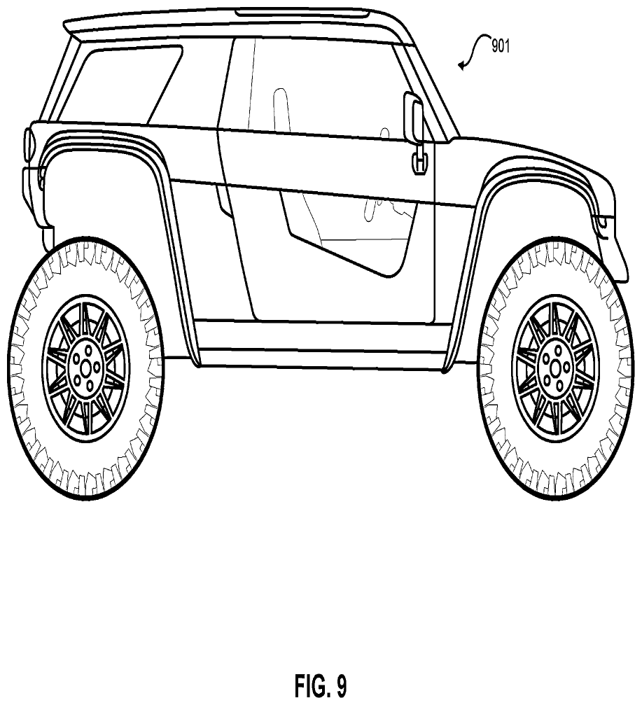

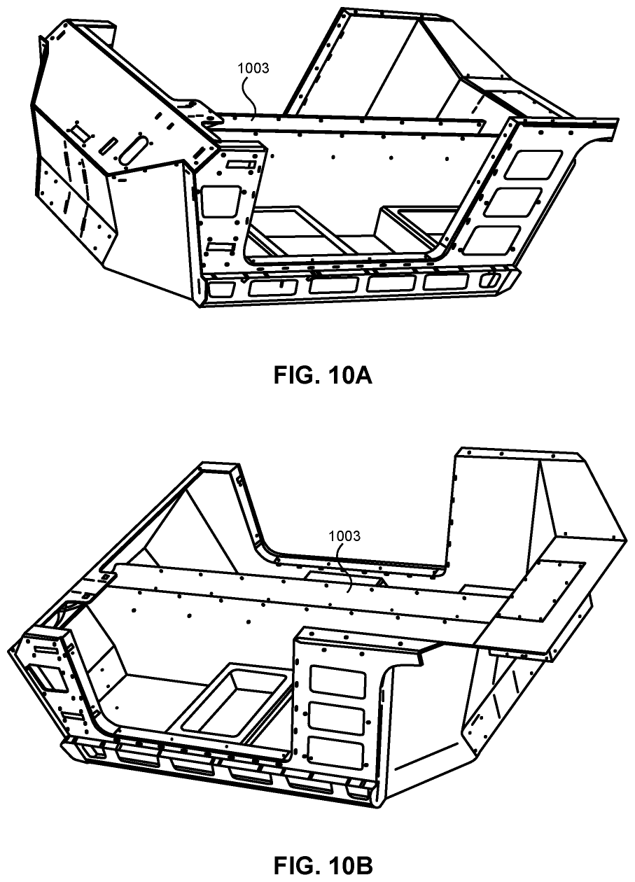

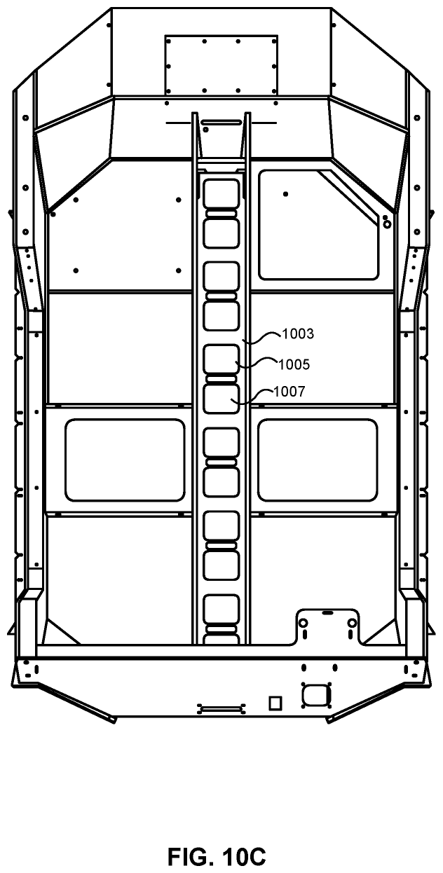

FIG. 9 illustrates an example of a motorized vehicle 901 in which at least some of the battery systems described herein may be implemented.

FIGS. 10A-C illustrate various views of a vehicle chassis with a battery spine, in which vehicle at least some of the battery systems described herein may be implemented. In various implementations, one or more battery systems may be secured in a battery compartment 1003 along a spine of the vehicle. The battery systems are placed in the battery compartment 1003. In some embodiments the battery systems are arranged in pairs such as battery systems 1005 and 1007. Such structure and other similar structures and arrangements are described further in U.S. Provisional Patent Application No. 63/228,139 entitled “ELECTRIC VEHICLE WITH BATTERY COMPARTMENT.”

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure. Elements of processes (i.e., methods) described herein may be executed in one or more ways such as by a human, by a processing device, by mechanisms operating automatically or by human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely examples. Particular implementations may vary from these example details and still be contemplated to be within the scope of the present implementations. [0043] Related elements in the examples and/or implementations described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or Dis an example that includes any of the elements A, B, C, and D. Unless otherwise stated, an example including a list of alternatively inclusive elements does not preclude other examples that include various combinations of some or all of the alternatively inclusive elements. An example described using a list of alternatively inclusive elements includes at least one element of the listed elements. However, an example described using a list of alternatively inclusive elements does not preclude another example that includes all of the listed elements. An example described using a list of alternatively inclusive elements does not preclude another example that includes a combination of some of the listed elements. As used herein regarding a list, “and/or” forms a list of elements inclusive alone or in any combination. For example, an example described as including A, B, C, and/or D is an example that may include A alone; A and B; A, Band C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower, or equal in scope to the original claims, are to be considered within the subject matter of the examples described herein.

The invention has been described with reference to various specific and preferred embodiments and techniques. Nevertheless, it is understood that many variations and modifications may be made while remaining within the spirit and scope of the invention.

What is claimed is:

1. A rechargeable battery system comprising:
a collection of at least four flat cells, each with a positive terminal extending from one side of each cell and a negative terminal extending from an opposite side of each cell, and arranged and connected in an alternating stack with a first stack side and second stack side, and wherein the cells are arranged such that each cell, except for a cell at one end of the stack, has its positive terminal mechanically and electrically connected at a junction to the negative terminal of an adjacent cell, and such that each cell, except for a cell at the other end of the stack, has its negative terminal mechanically and electrically connected at a junction to the positive terminal on an adjacent cell;
a first board located on the first stack side, the board comprising:
a plurality of first connectors extending from the first board for mechanically and electrically connecting to the junctions on the first stack side;
a battery management processor;
first electrical conductors to electrically connect each first connector of the plurality of first connectors to the battery management processor;
whereby the state of at least each pair of cells connected at each first connector can be monitored by the battery management processor.

2. The system of claim 1, wherein the mechanical and electrical connection of the junctions on the first stack side to the first connectors is achieved simultaneously by moving the first board and the first stack side toward each other.

3. The system of claim 2, wherein the junctions on the first stack side are mechanically and electrically connected to the first connectors by means of a blade and receptacle type quick connection.

4. The system of claim 3, wherein each pair of a welded positive and negative terminal forms a blade for a blade and receptacle type quick connection.

5. The system of claim 4, wherein the first connectors are in the form of a spring clip type quick connection.

6. The system of claim 5, wherein the first connectors on the first board and the blades of the positive and negative terminals on the first stack side are configured so that the board is installable in a single orientation.

7. The system of claim 1, wherein the first board is a first printed circuit board, and wherein the first electrical conductors are first traces on the first printed circuit board.

8. The system of claim 1 further comprising a second board located on the second stack side, the second board comprising:
a plurality of second connectors extending from the second board for mechanically and electrically connecting to the junctions on the second stack side;
second electrical conductors to directly or indirectly connect each second connector of the plurality of second connectors to the battery management processor;
whereby the state of each cell can be monitored by the battery management processor.

9. The system of claim 8, wherein the mechanical and electrical connection of the junctions on the second stack side to the second connectors is achieved simultaneously by moving the second board and the second stack side toward each other.

10. The system of claim 9, wherein the junctions on the second stack side are mechanically and electrically connected to the second connectors by means of a blade and receptacle type quick connection.

11. The system of claim 10, wherein each of the positive terminals and each of the negative terminals is in the shape of a flat ribbon, and wherein the positive terminals on the first stack side are mechanically and electrically attached to negative terminals on the first stack side by welding, and the positive terminals on the second stack side are mechanically and electrically attached to negative terminals on the second stack side by welding.

12. The system of claim 11, wherein the second connectors are in the form of a spring clip for the blade and receptacle type quick connection.

13. The system of claim 12, wherein the second connectors on the second board and the blades of the positive and negative terminals on the second side are configured so that the second board is installable in a single orientation.

14. The system of claim 13, wherein the configuration of first connectors and the blade of the positive and negative terminals on the first stack side are different from the configuration of second connectors and the blade of the positive and negative terminals on the second side so that the first board is installable only on a first stack side and the second board is installable only on a second stack side.

15. The system of claim 8, further comprising a multiconductor cable for joining the second conductors on the second board with third conductors on the first board, which third conductors are electrically connected to the battery management processor, to thereby electrically connect the second connectors to the battery management processor.

16. The system of claim 8, further comprising a cell support structure that supports the stack of cells, wherein the second board is attached to the battery cell support structure.

17. A method for manufacturing a rechargeable battery system comprising:
providing a collection of at least four flat cells, each with a positive terminal extending from one side of each cell and a negative terminal extending from an opposite side of each cell;
arranging the cells in an alternating stack with a first stack side and a second stack side, the cells arranged such that the positive terminal of every other cell is on the first stack side and the negative terminals of the remaining cells are on the first stack side, and such that the negative terminal of every other cell is on the second stack side and the positive terminals of the remaining cells are on the second stack side;
mechanically and electrically connecting the positive terminals of the cells on each side to the negative terminals of the adjacent cells on the same side at a junction;
connecting the cell at one end of the stack to a first electrical lead, and the cell at the other end to a second electric lead, wherein one of the leads is positive and the other is negative;
providing a first board located on the first stack side, the board comprising:
a plurality of first connectors extending from the first board for mechanically and electrically connecting to the junctions on the first stack side;
a battery management processor;
first electrical conductors to electrically connect each first connector of the plurality of first connectors to the battery management processor;
whereby the state of at least each pair of cells connected at each first connector can be monitored by the battery management processor;
moving the first board and the first stack side toward each other to mechanically and electrically connect the junctions on the first stack side to the first connectors on the first board.

18. The method of claim 17, further comprising:
providing a second board located on the second stack side, the second board comprising:
a plurality of second connectors extending from the second board for mechanically and electrically connecting to the junctions on the second stack side;
second electrical conductors to directly or indirectly connect each second connector of the plurality of second connectors to the battery management processor;
moving the second board and the second stack side toward each other to mechanically and electrically connect the junctions on the second stack side to the second connectors on the second board.
whereby the state of each cell can be monitored by the battery management processor.

19. The method of claim 18, wherein the second connectors on the second board and the blades of the positive and negative terminals on the second side are configured so that the board is installable in a single orientation.

20. The method of claim 19, wherein the configuration of first connectors on the first board and the blades of the positive and negative terminals on the first stack side are different from the configuration of second connectors on the second board and the blades of the positive and negative terminals on the second side so that the first board is installable only on a first stack side and the second board is installable only on a second side.
